(19) United States
(12) Patent Application Publication
(10) Pub. No.: US 2026/0202250 A1
(43) Pub. Date: Jul. 16, 2026

(54) SPECTROSCOPIC CAMERA AND CORRECTION VALUE CALCULATION METHOD FOR SPECTROSCOPIC CAMERA

(71) Applicant: SEIKO EPSON CORPORATION, TOKYO (JP)

(72) Inventor: Shota YAMANAKA, MATSUMOTO-SHI (JP)

(21) Appl. No.: 19/449,614

(22) Filed: Jan. 15, 2026

(30) Foreign Application Priority Data
Jan. 15, 2025 (JP) 2025-005218

(51) Int. Cl. G01J 3/28; G01J 3/02

(52) U.S. Cl. CPC G01J 3/2823; G01J 3/0205; G01J 2003/2843

(57) ABSTRACT

A spectroscopic camera 1 includes a relay lens optical system 19 configured to image light from an object and generate a first intermediate image at a predetermined position P1, a wavelength variable spectral filter 14 configured to spectrally separate the light from the relay lens optical system 19, an image sensor 15 configured to detect the light from the wavelength variable spectral filter 14, and a processor 20 configured to correct a spectral sensitivity characteristic of the wavelength variable spectral filter 14, wherein the processor 20 is configured to correct the spectral sensitivity characteristic of the wavelength variable spectral filter 14 so that the spectral sensitivity characteristic at an arbitrary correction point of a spectral image detected by the image sensor 15 approaches a spectral sensitivity characteristic at the predetermined reference point of the spectral image or a predetermined spectral sensitivity characteristic reference value.

The present application is based on, and claims priority from JP Application Serial Number 2025-005218, filed January 15, 2025, the disclosure of which is hereby incorporated by reference herein in its entirety.

### BACKGROUND

### 1. Technical Field

The present disclosure relates to a spectroscopic camera and a correction value calculation method for the spectroscopic camera.

### 2. Related Art

In a spectroscopic camera using a Fabry-Perot type wavelength variable spectral filter (etalon), in order to suppress wavelength unevenness of a spectral image, calibration of spectral sensitivity characteristic of the wavelength variable spectral filter is performed (see JP-A-2020-176873).

In the calibration method of JP-A-2020-176873, uniform light having uniform in-plane intensity is emitted from the spectral light source, and this uniform light is detected by the spectroscopic camera, which is to target of calibration, and the spectrophotometer, which is the calibration standard, and a correction value for the spectroscopic camera is calculated from each spectral image.

In a spectroscopic camera, an interchangeable lens is used in some cases, and when the lens is replaced, the incident angle characteristic to the wavelength variable spectral filter may change. In this case, if the same correction value is used, a correction error becomes large, and the desired spectral performance cannot be obtained.

An object of the present disclosure is to provide a spectroscopic camera and a correction value calculation method for the spectroscopic camera that can obtain desired spectral performance without performing a calibration operation even when the lens is replaced.

### SUMMARY

A spectroscopic camera according to one aspect of the present disclosure includes a relay lens optical system configured to image light from an object and to generate a first intermediate image at a predetermined position; a wavelength variable spectral filter configured to spectrally separate the light from the relay lens optical system; an image sensor configured to detect the light from the wavelength variable spectral filter; and a processor configured to correct a spectral sensitivity characteristic of the wavelength variable spectral filter, wherein the processor is configured to correct the spectral sensitivity characteristic of the wavelength variable spectral filter so that the spectral sensitivity characteristic at an arbitrary correction point of a spectral image detected by the image sensor approaches a spectral sensitivity characteristic at a predetermined reference point of the spectral image or a predetermined spectral sensitivity characteristic reference value.

A correction value calculation method for a spectroscopic camera according to another aspect of the present disclosure is a correction value calculation method for a spectroscopic camera that calculates a spectral characteristic correction value of the wavelength variable spectral filter of the spectroscopic camera according to the above described aspect of the present disclosure, the method including in a state where a spectral light source emits uniform light of a first wavelength having a uniform in-plane intensity is disposed at an imaging position of the first intermediate image, a spectral characteristic correction value is calculated such that the spectral sensitivity characteristic at the arbitrary correction point of the spectral image detected by the image sensor approaches the spectral sensitivity characteristic at a predetermined reference point of the spectral image or the predetermined spectral characteristic reference value.

### BRIEF DESCRIPTION OF THE DRAWINGS

FIG. 1 is a schematic diagram illustrating a spectroscopic camera according to a first embodiment of the present disclosure.

FIG. 2 is a flowchart showing a correction process according to the first embodiment.

FIG. 3 is a schematic diagram illustrating a correction value calculation device according to the first embodiment.

FIG. 4 is a schematic diagram illustrating a correction point and a reference point in the first embodiment.

FIG. 5 is a flowchart showing a correction value calculation process according to the first embodiment.

FIG. 6 is a schematic diagram illustrating a spectroscopic camera according to a second embodiment of the present disclosure.

FIG. 7 is a schematic diagram illustrating a spectroscopic camera according to a third embodiment of the present disclosure.

### DESCRIPTION OF EMBODIMENTS

### FIRST EMBODIMENT

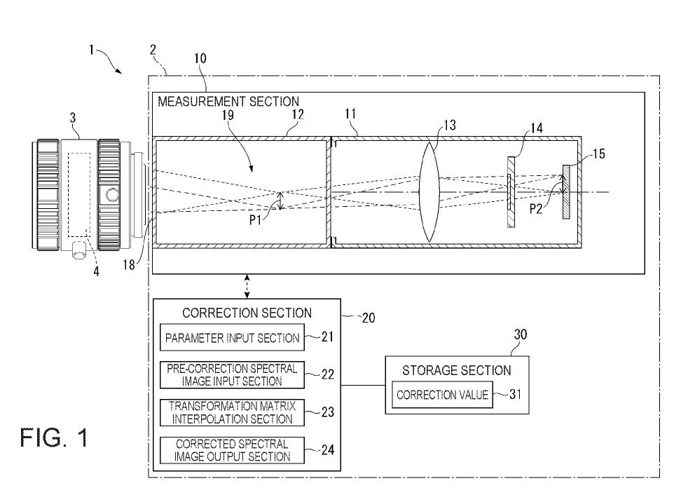

FIG. 1 illustrates a spectroscopic camera 1 according to a first embodiment of the present disclosure.

The spectroscopic camera 1 includes a camera body 2 and an interchangeable lens 3.

The interchangeable lens 3 is an attachable and detachable lens selected according to the application or the like, and includes a first optical system 4 therein. The first optical system 4 can image an image of light from an external object to generate a first intermediate image at a predetermined position P1 of the camera body 2.

The camera body 2 has a measurement section 10, a processor 20, and a storage 30.

The measurement section 10 has a camera housing 11 and a lens adapter housing 12. One end of the lens adapter housing 12 is attached to the camera housing 11, and the interchangeable lens 3 is attached to the other end. For this purpose, a mount 18 to which the interchangeable lens 3 can be attached is formed in the lens adapter housing 12. In a state where the interchangeable lens 3 is mounted on the mount 18, a position P1 where the first intermediate image is generated by the first optical system 4 is inside the lens adapter housing 12.

A second optical system 13, a wavelength variable spectral filter 14, and an image sensor 15 are installed inside the camera housing 11.

The second optical system 13 re-images the light from the first intermediate image generated at the position P1 to generate a second intermediate image at a position P2 of the image sensor 15. In the present embodiment, the first optical system 4 and the second optical system 13 constitute a relay lens optical system 19.

The wavelength variable spectral filter 14 is disposed between the second optical system 13 and the image sensor 15, and spectrally separates the light reaching the image sensor 15 from the first intermediate image.

The image sensor 15 detects the light spectrally separated by the wavelength variable spectral filter 14 and outputs a spectral image as data.

The processor 20 performs correction for suppressing in-plane wavelength unevenness on the spectral image output from the image sensor 15.

The storage 30 stores a correction value 31 used by the processor 20.

The correction value 31 is calculated by a correction value calculation process (to be described later) to correct a spectral sensitivity characteristic of the wavelength variable spectral filter 14, which causes in-plane wavelength unevenness of the spectral image, and is stored in the storage 30. The correction value 31 is, for example, in the form of a transformation matrix M(i, j, n, n). In the transformation matrix M(i, j, n, n), i and j indicate the positions of correction points in the spectral image, i is the position in a horizontal direction of the spectral image, and j is the position in a vertical direction of the spectral image. The transformation matrix M(i, j, n, n) is a matrix of n rows × n columns, and changes depending on the number of measurement bands of the wavelength variable spectral filter 14. For example, in the present embodiment, the wavelength variable spectral filter 14 is a filter capable of spectral light in a range of wavelengths from 400nm to 700nm at 20nm intervals (16 bands). In this case, the transformation matrix M(I, j, n, n) is represented by a matrix of 16 rows and 16 columns.

The processor 20 includes a parameter input section 21, a pre-correction spectral image input section 22, a transformation matrix interpolation section 23, and a post-correction spectral image output section 24.

The parameter input section 21 acquires the correction value 31 stored in the storage 30 and receives a parameter input necessary for correction.

The pre-correction spectral image input section 22 acquires a spectral image D as a correction target from the image sensor 15.

The transformation matrix interpolation section 23 performs interpolation from the transformation matrix M (i, j, n, n) at each correction point position(xi, yi) using the transformation matrix M(i, j, n, n) acquired as the correction value 31, and obtains the transformation matrix M(x, y) at each pixel(x, y) of the spectral image D.

The post-correction spectral image output section 24 corrects each pixel(x, y) of the spectral image D using the transformation matrix M(x, y) obtained by the transformation matrix interpolation section 23 and outputs the corrected pixel.

For example, assuming that the pixel value of the spectral image of the pixel (x, y) is D (x, y) and the pixel value after the correction is Dc (x, y), then Dc (x, y) = M (x, y) D (x, y) is satisfied. In the corrected spectral image, the in-plane wavelength unevenness caused by the deviation of the spectral sensitivity characteristic of the wavelength variable spectral filter 14 is eliminated.

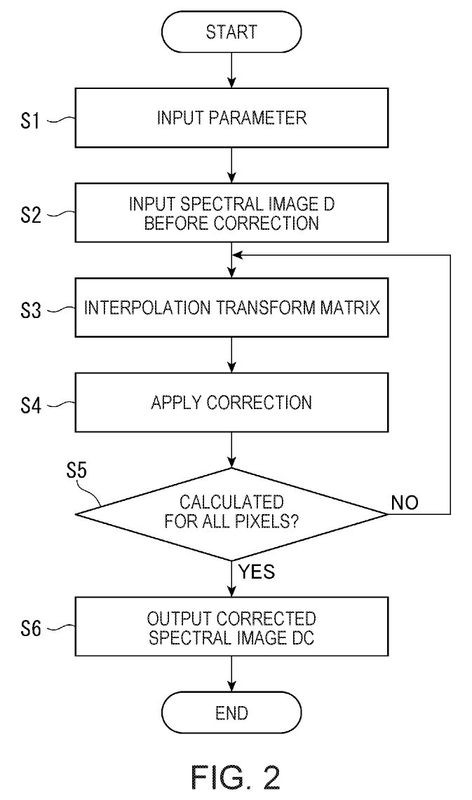

FIG. 2 shows a correction process of the spectral image in the spectroscopic camera 1.

After the parameter input section 21 receives the parameter input (process S1), the processor 20 inputs the spectral image D before correction is detected by the image sensor 15 at the pre-correction spectral image input section 22 (process S2). Next, the transformation matrix interpolation section 23 and the post-correction spectral image output section 24 interpolate the transformation matrix M(x, y) from the transformation matrix M(i, j), which is the correction value 31, for each pixel(x, y) of the spectral image D (process S3), and obtain the corrected spectral image Dc (process S4). When the process S3 and the process S4 are calculated for all the pixels (process S5), the corrected spectral image Dc is output (process S6).

### Correction value calculation device

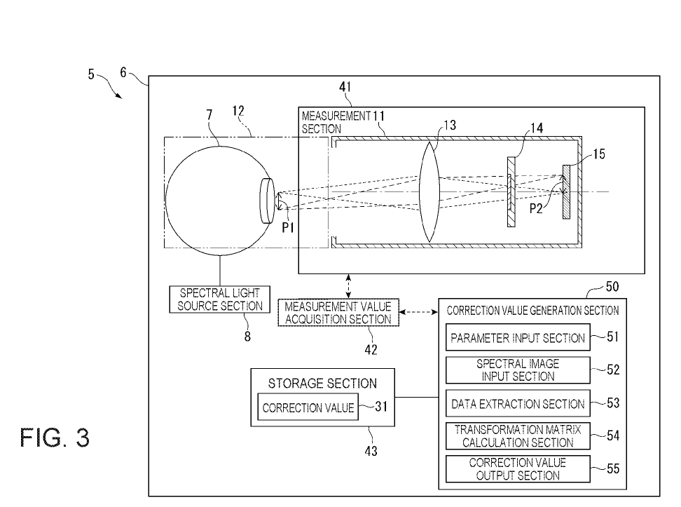

FIG. 3 shows a correction value calculation device 5 for calculating the correction value 31.

The correction value calculation device 5 has an integrating sphere 7, a spectral light source 8, and a measurement section 41 inside a light-shielding housing 6. A measurement value acquisition section 42, a storage 43, and a correction value generation section 50 are connected to the measurement section 41.

The spectral light source 8 emits light of a designated wavelength to the integrating sphere 7, and light of a first wavelength having uniform in-plane intensity is emitted from the integrating sphere 7.

The camera housing 11 taken out from the measurement section 10 of the spectroscopic camera 1 described above is mounted on the measurement section 41. The second optical system 13, the wavelength variable spectral filter 14, and the image sensor 15 are installed inside the camera housing 11.

In the measurement section 41, the lens adapter housing 12 connected to the camera housing 11 in the spectroscopic camera 1 is removed, and a surface of the integrating sphere 7 is disposed at a position corresponding to the position P1 where the first intermediate image is generated in the lens adapter housing 12.

That is, in the spectroscopic camera 1, the light from the first intermediate image generated at the position P1 is incident on the second optical system 13, whereas in the correction value calculation device 5, the uniform light from the spectral light source 8 and the integrating sphere 7 is incident on the second optical system 13.

The light incident on the second optical system 13 is spectrally separated by the wavelength variable spectral filter 14 and is received by the image sensor 15.

The measurement value acquisition section 42 acquires the spectral image from the image sensor 15 and delivers the spectral image to the correction value generation section 50. The spectral image acquired here is an image obtained by detecting the uniform light from the spectral light source 8 and the integrating sphere 7 by the image sensor 15 through the second optical system 13 and the wavelength variable spectral filter 14 inside the camera housing 11 mounted on the measurement section 41, and reflects the spectral sensitivity characteristic of the wavelength variable spectral filter 14 for each wavelength. The spectral images are captured by n × λ pieces of images of a plurality of light source wavelengths λ by the spectral light source 8, with the wavelength variable spectral filter 14 as a plurality of spectral wavelengths n.

The correction value generation section 50 has a parameter input section 51, a spectral image input section 52, a data extraction section 53, a transformation matrix calculation section 54, and a correction value output section 55.

The parameter input section 51 receives parameter input necessary for generating a correction value.

Here, in a case where a reference for generating the correction value is the spectral sensitivity characteristic of a predetermined reference point of the spectral image, a pixel position or a pixel region to be referred to as the reference point is designated.

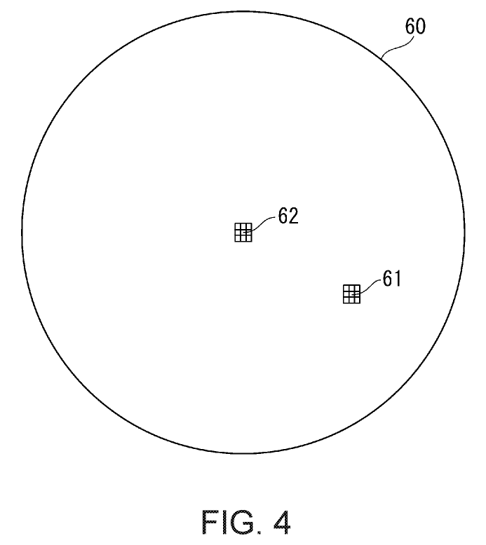

In FIG. 4, as a reference for a correction value at an arbitrary correction point 61 of a spectral image 60, for example, a pixel or a pixel region at the center of the spectral image 60 can be used as a reference point 62. The reference point 62 may be another pixel or pixel region in the central portion of the spectral image 60.

When a predetermined spectral sensitivity characteristic reference value is used as the reference for generating the correction value, the corresponding spectral sensitivity characteristic reference value is input. As a reference value of the spectral sensitivity characteristic, a design value of the wavelength variable spectral filter 14 of the spectroscopic camera 1 or the like may be used.

The spectral image input section 52 inputs the spectral image acquired by the measurement value acquisition section 42.

The data extraction section 53 extracts data of the spectral sensitivity characteristic for the arbitrary correction point for generating the correction value of wavelength unevenness among the input spectral image. The correction point may be any pixel, and data smoothing and noise removal may be performed as the pixel region including any pixel and pixels around the pixel.

The transformation matrix calculation section 54 generates a transformation matrix M(i, j, n, n) for bringing the data S(i, j, n, λ) of the spectral sensitivity characteristic of the correction point(i, j) obtained by the data extraction section 53 approaches to a spectral sensitivity characteristic So(n, λ) as a reference designated by the parameter input section 51. Here, n is a variable indicating a target spectral wavelength to be transmitted through the wavelength variable spectral filter 14, and λ indicates a wavelength of measurement light emitted from the spectral light source 8. For example, in a case where the wavelength variable spectral filter 14 can spectrally separate the wavelengths in the visible region from 400nm to 700nm into spectral wavelengths of 16 bands (n=16) at 20nm intervals, the wavelengths in the visible region from 400nm to 700nm of the light emitted from the spectral light source 8 are sequentially switched at 5nm intervals. Then, the target spectral wavelength of the wavelength variable spectral filter 14 is sequentially switched for the light of each wavelength of the spectral light source 8, and thus 16 × 61 measurement values are obtained. In this case, S(i, j, n, λ) and So(n, λ) are expressed in a 16 × 61 matrix, and the transformation matrix calculation section 54 calculates the transformation matrix M(i, j, n, n) that brings S(i, j, n, λ) closer to So(n, λ).

The correction value output section 55 stores the transformation matrix M(i, j) of each correction point(I, j) obtained by the transformation matrix calculation section 54 in the storage 43 as the correction value 31. The stored correction value 31 is transferred to the storage 30 of the spectroscopic camera 1 by a separate communication unit or the like.

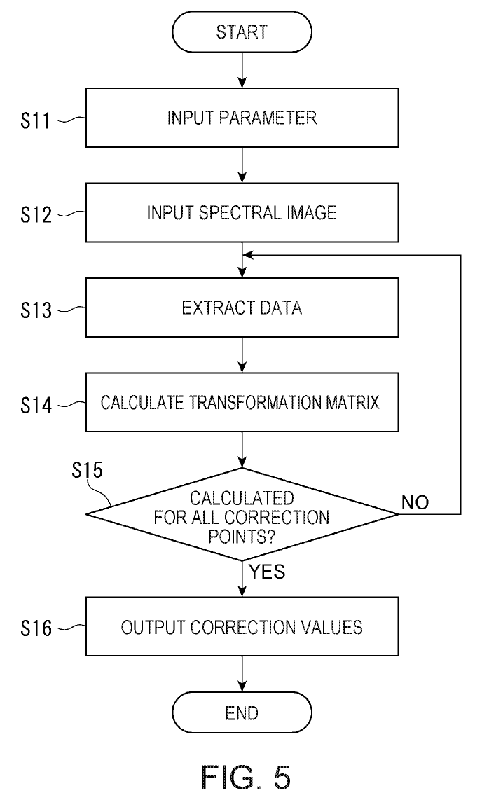

FIG. 5 shows a process of calculating the correction value 31 in the correction value calculation device 5.

After the parameter input section 51 receives the parameter input (process S11), the correction value generation section 50 inputs the spectral image detected by the image sensor 15 in the spectral image input section 52 (process S12). Next, in the data extraction section 53 and the transformation matrix calculation section 54, the spectral sensitivity characteristic data S(i, j, n, λ) is extracted for each correction point (i, j) of the spectral image (process S13), and the transformation matrix M(i, j, n, n) that approaches the reference spectral sensitivity characteristic So(n, λ) (process S14) is generated. Once the process S13 and the process S14 are calculated for all the correction points (process S15), the correction values are output (process S16).

### Effects of present embodiment

The spectroscopic camera 1 of the present embodiment includes the relay lens optical system 19 configured to image an image light from the object to generate the first intermediate image at the predetermined position p1, the wavelength variable spectral filter 14 configured to spectrally separate the light from the relay lens optical system 19, the image sensor 15 configured to detect the light from the wavelength variable spectral filter 14, and the processor 20 configured to correct the spectral sensitivity characteristic of the wavelength variable spectral filter 14, wherein the processor 20 has a configuration that corrects the spectral sensitivity characteristic of the wavelength variable spectral filter 14 so that the spectral sensitivity characteristic at the arbitrary correction point 61 of the spectral image 60 detected by the image sensor 15 approaches the spectral sensitivity characteristic at the predetermined reference point 62 of the spectral image 60 or the predetermined spectral sensitivity characteristic reference value.

With this configuration, the wavelength variable spectral filter 14 is corrected by the processor 20 such that all the pixels approach the spectral sensitivity characteristic at the center of the spectral image, and the in-plane wavelength unevenness of the spectral image detected by the image sensor 15 can be suppressed. As a result, the spectroscopic camera 1 can obtain the desired spectral performance.

The correction value 31 is generated by the correction value calculation device 5 and stored in the storage 30 in advance, and it is not necessary to perform a calibration operation when the spectroscopic camera 1 is used. In particular, in the generation of the correction value 31 by the correction value calculation device 5, the position P1 at which the first intermediate image is generated is positioned on the integrating sphere and the position P1 is a fixed position regardless of the type of the interchangeable lens 3. Since the correction value 31 is generated based on uniform light having a uniform in-plane intensity at the position of the first intermediate image, the correction value 31 can be independent of the interchangeable lens 3. As a result, in the spectroscopic camera 1, even when the interchangeable lens 3 is replaced, the in-plane wavelength unevenness of the spectral image can be suppressed using the same correction value 31. Then, the calibration operation of the related art, which is performed every time the interchangeable lens 3 is replaced, can be made unnecessary, and the correction value for each interchangeable lens 3 can also be made unnecessary.

The spectroscopic camera 1 of the present embodiment, wherein the relay lens optical system 19 has the attachable and detachable first optical system 4 configured to image the light from the object and to generate the first intermediate image at the predetermined position P1, and the second optical system 13 configured to re-image the light from the first intermediate image on the image sensor 15 and the wavelength variable spectral filter 14 is disposed between the second optical system 13 and the image sensor 15 and has the housing (the camera housing 11 and the lens adapter housing 12) that accommodates the second optical system 13 and the wavelength variable spectral filter 14, and the lens adapter housing 12 is provided with the mount 18 to which the interchangeable lens 3 including the first optical system 4 can be attached.

In this configuration, the relay lens optical system is configured by the first optical system and the second optical system, and the light from the object is delivered via the first intermediate image. Since the first optical system 4 is accommodated in the interchangeable lens 3 and is attachable and detachable, the first intermediate image can be generated at the predetermined position even when the interchangeable lens 3 is replaced according to the application. By installing the wavelength variable spectral filter 14 between the second optical system 13 and the image sensor 15, the light from the first intermediate image can be spectrally separated by the wavelength variable spectral filter 14, and then, re-imaged on the image sensor 15. By this, regardless of which interchangeable lens 3 having the first optical system 4 is used, the light from the object can be used to generate the first intermediate image at the predetermined position P1, and the interchangeable lens 3 can be replaced and used depending on the application of the spectroscopic camera 1, or the like.

The spectroscopic camera 1 of the present embodiment, wherein the processor 20 is configured to read the correction value 31 stored in the storage 30 and to correct the spectral sensitivity characteristic of the wavelength variable spectral filter 14 and the correction value 31 is a value calculated from the spectral image detected by the image sensor 15 in a state where the spectral light source 8 and the integrating sphere 7, which are configured to emit uniform light of the first wavelength having an in-plane uniform intensity, are disposed so that the first intermediate image is formed at the position P1.

With this configuration, it is possible to perform calibration of the spectral sensitivity characteristic using uniform light with respect to a portion from the position P1 of the first intermediate image that reaches the image sensor 15 through the second optical system 13 and the wavelength variable spectral filter 14, and it is possible to correct the spectral sensitivity characteristic of an effective wavelength variable spectral filter 14 even in a case where the interchangeable lens 3 is replaced with any interchangeable lens 3 having the first optical system 4.

### SECOND EMBODIMENT

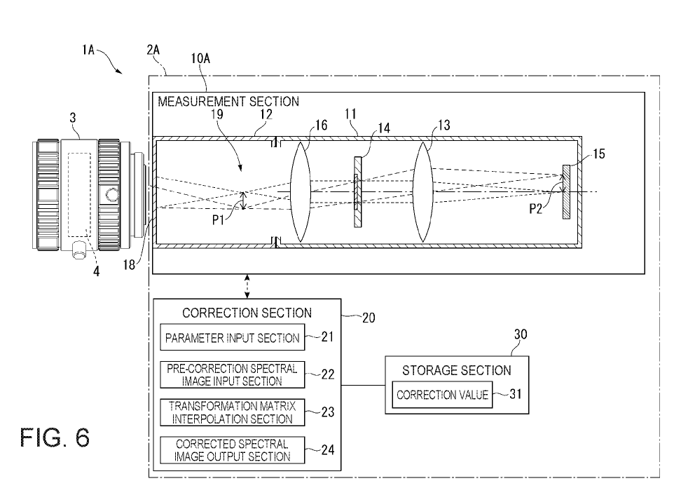

Another embodiment of the present disclosure is illustrated in FIG. 6.

In a spectroscopic camera 1A of the present embodiment, a measurement section 10A installed in a camera body 2A is different from that of the first embodiment described above, but the interchangeable lens 3 mounted on the camera body 2A, the processor 20 and the storage 30, which are other configurations of the camera body 2A, and the correction value calculation device 5 that calculates the correction value 31 are the same as those of the first embodiment described above. Therefore, the description of the common elements will be omitted, and the portions different from the first embodiment will be described below.

In the measurement section 10A, the camera housing 11, the lens adapter housing 12 having the mount 18, the second optical system 13 installed inside the camera housing 11, and the image sensor 15 are the same as those in the first embodiment described above.

In the measurement section 10A, the wavelength variable spectral filter 14 is disposed between the first optical system 4 and the second optical system 13. An additional optical system 16 is installed on the incident side of the wavelength variable spectral filter 14. That is, the wavelength variable spectral filter 14 is disposed between the additional optical system 16 and the second optical system 13.

The additional optical system 16 telecentrically converts light from the first intermediate image generated at the position P1 and makes the light incident on the wavelength variable spectral filter 14. The light from the second optical system 13 to the image sensor 15 is also telecentrically converted.

According to the second embodiment, the same effects as those of the first embodiment can be obtained by the same configuration as that of the first embodiment, and also the following effects can be obtained.

The spectroscopic camera 1A of the present embodiment has the additional optical system 16 that is disposed between the first intermediate image and the wavelength variable spectral filter 14 and that telecentrically converts the light incident on the wavelength variable spectral filter 14.

With this configuration, in the measurement section 10A, the light incident on the wavelength variable spectral filter 14 becomes telecentric light by the additional optical system 16, and thus, a principal light beam of the light incident with respect to the wavelength variable spectral filter 14 can be made parallel to each other, and it is possible to prevent deterioration of spectral characteristic due to variation in incident angle. For example, since the principal light beam on an optical axis (light imaged at the center point of the spectral image) and the principal light beam off the optical axis (light imaged at a point away from the center point of the spectral image) are parallel to each other, it is suitable for suppressing variation in the spectral sensitivity characteristic in the plane generated due to the angle of the light beam incident on the wavelength variable spectral filter 14.

In the spectroscopic camera 1A of the present embodiment, the light emitted from the second optical system 13 is telecentric light.

With this configuration, since the light incident on the image sensor 15 becomes telecentric light, it is suitable for suppressing variation in the spectral sensitivity characteristic in the plane generated due to the angle of the light beam incident on the image sensor 15.

### THIRD EMBODIMENT

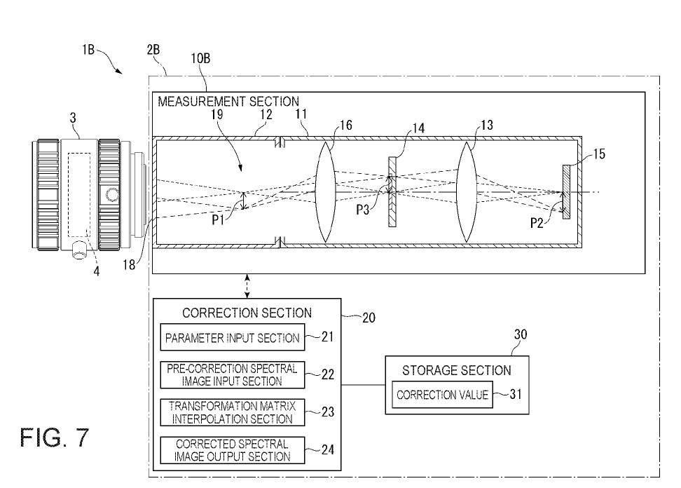

Another embodiment of the present disclosure is illustrated in FIG. 7.

In a spectroscopic camera 1B of the present embodiment, a measurement section 10B installed in a camera body 2B is different from that of the first embodiment described above, but the interchangeable lens 3 mounted on the camera body 2B, the processor 20 and the storage 30 which are other configurations of the camera body 2B, and the correction value calculation device 5 that calculates the correction value 31 are the same as those of the first embodiment described above. Therefore, the description of the common elements will be omitted, and the portions different from the first embodiment will be described below.

The measurement section 10B of the present embodiment includes the second optical system 13, the wavelength variable spectral filter 14, the image sensor 15, and the additional optical system 16, as does the measurement section 10A of the second embodiment described above. However, in the present embodiment, the light emitted from the additional optical system 16 images at the position P3 on the front face of the wavelength variable spectral filter 14, and the second intermediate image is generated.

According to the third embodiment, the same effects as those of the first embodiment can be obtained by the same configuration as that of the first embodiment, and the following effects can also be obtained.

The spectroscopic camera 1B of the present embodiment has the additional optical system 16 that is disposed between the first intermediate image and the wavelength variable spectral filter 14 and images the light from the first intermediate image on the wavelength variable spectral filter 14 as the second intermediate image.

In the present embodiment, as in the first embodiment, the correction value 31 is calculated based on the uniform light having a uniform in-plane intensity at the position of the first intermediate image. Therefore, in this configuration, when the camera housing 11 of the spectroscopic camera 1B is set in the correction value calculation device 5, the in-plane intensity of the light is uniform even at the position of the second intermediate image, and the in-plane intensity of the image imaged on the image sensor 15 is also uniform. By this, it is possible to calculate the correction value 31 that can further suppress the in-plane intensity unevenness.

### Modifications

The present disclosure is not limited to the above described embodiments, and modifications and the like within a range in which the object of the present disclosure can be achieved are included in the present disclosure.

The present disclosure is not limited to using the spectral sensitivity characteristic of the reference point 62 at the center of the spectral image as a reference, as in the correction value 31 described in the above embodiment, but may also use the spectral sensitivity characteristic of another point on the spectral image as a reference. Alternatively, instead of actually measuring the spectral sensitivity characteristic of the portion from the first intermediate image through the second optical system 13 and the wavelength variable spectral filter 14 to the image sensor 15 and using this as a reference, the predetermined spectral sensitivity characteristic reference value, such as the design value of the wavelength variable spectral filter 14 or a measurement value using a calibrator, may be input.

In the above described embodiments, the first optical system 4, the second optical system 13, or the additional optical system 16 is illustrated and described in a simplified manner, but a combination of a plurality of elements can be used so as to obtain the desired optical characteristic.

### Summary of present disclosure

The spectroscopic camera according to the first aspect of the present disclosure includes a relay lens optical system configured to image light from an object and to generate a first intermediate image at a predetermined position; a wavelength variable spectral filter configured to spectrally separate the light from the relay lens optical system; an image sensor configured to detect the light from the wavelength variable spectral filter; and a processor configured to correct a spectral sensitivity characteristic of the wavelength variable spectral filter, wherein the processor is configured to correct the spectral sensitivity characteristic of the wavelength variable spectral filter so that the spectral sensitivity characteristic at an arbitrary correction point of a spectral image detected by the image sensor approaches a spectral sensitivity characteristic at a predetermined reference point of the spectral image or a predetermined spectral sensitivity characteristic reference value.

In this configuration, the wavelength variable spectral filter is corrected by the processor such that all the pixels approach the spectral sensitivity characteristic at the center of the spectral image, and the in-plane wavelength unevenness of the spectral image detected by the image sensor can be suppressed. As a result, the spectroscopic camera can obtain the desired spectral performance.

The correction value is stored in the storage in advance, and it is not necessary to perform the calibration operation when the spectroscopic camera is used. The correction value is generated so as to approach the spectral sensitivity characteristic at the predetermined reference point or the predetermined spectral sensitivity characteristic reference value by acquiring the spectral image by the wavelength variable spectral filter in a state where the interchangeable lens is not present, and can be independent of the interchangeable lens. As a result, in the spectroscopic camera, even when the interchangeable lens is replaced, the in-plane wavelength unevenness of the spectral image can be suppressed using the same correction value. Then, the calibration operation of the related art, which is performed every time the interchangeable lens is replaced, can be omitted.

The spectroscopic camera according to the present disclosure, wherein the relay lens optical system has an attachable and detachable first optical system configured to image the light from the object and to generate the first intermediate image at the predetermined position, and a second optical system configured to re-image the light from the first intermediate image on the image sensor, the wavelength variable spectral filter is disposed between the first optical system and the second optical system or between the second optical system and the image sensor, the wavelength variable spectral filter has a housing configured to accommodate the second optical system and the wavelength variable spectral filter, and the housing is formed with a mount to which the first optical system is attachable.

In this configuration, the relay lens optical system is configured by the first optical system and the second optical system, and the light from the object is delivered via the first intermediate image. Since the first optical system is attachable and detachable, the first intermediate image can be generated at the predetermined position even when the lens is replaced according to the application. By installing the wavelength variable spectral filter between the second optical system and the image sensor, the light from the first intermediate image can be spectrally separated by the wavelength variable spectral filter, and then, re-imaged on the image sensor. By this, regardless of which the interchangeable lens having the first optical system is used, the light from the object can be used to generate the first intermediate image at the predetermined position, and the interchangeable lens can be replaced and used depending on the application of the spectroscopic camera, or the like.

The spectroscopic camera according to the present disclosure, wherein the processor is configured to read a correction value stored in a storage and to correct the spectral sensitivity characteristic of the wavelength variable spectral filter and the correction value is a value calculated from the spectral image detected by the image sensor in a state where a spectral light source configured to emit uniform light of a first wavelength having a uniform in-plane intensity is disposed at an imaging position of the first intermediate image.

With this configuration, it is possible to perform calibration of the spectral sensitivity characteristic using uniform light with respect to a portion from the position of the first intermediate image that reaches the image sensor through the second optical system and the wavelength variable spectral filter, and it is possible to correct the spectral sensitivity characteristic of an effective wavelength variable spectral filter even in a case where the interchangeable lens is replaced with any interchangeable lens having the first optical system.

The spectroscopic camera according to the present disclosure, further including an additional optical system that is disposed between the first intermediate image and the wavelength variable spectral filter and that is configured to telecentrically convert light incident on the wavelength variable spectral filter, or an additional optical system that images the light from the first intermediate image on the wavelength variable spectral filter as a second intermediate image.

In the configuration in which the light incident on the wavelength variable spectral filter is made telecentrically converted by the additional optical system, it is possible to prevent deterioration of the spectral characteristic of the wavelength variable spectral filter. The angles of light beams imaging on the optical axis and off the optical axis can be made the same, and it is suitable for suppressing variation in the spectral sensitivity characteristic in the plane generated due to the angle of the light beam incident on the wavelength variable spectral filter.

In the configuration in which the additional optical system images the light from the first intermediate image as the second intermediate image on the wavelength variable spectral filter, even in a case where the diameter of the wavelength variable spectral filter is small, the height of the second intermediate image to be imaged can be reduced, and an image larger than the diameter of the wavelength variable spectral filter can be imaged on the image sensor while securing the amount of light from the wavelength variable spectral filter to the image sensor.

The spectroscopic camera according to the present disclosure, wherein the light emitted from the second optical system is telecentric light.

In this configuration, since the light incident on the image sensor is telecentric light, it is possible to suppress the variation in the spectral sensitivity characteristic in the plane generated due to the angle of the light beam incident on the image sensor.

The correction value calculation method for the spectroscopic camera according to the second aspect of the present disclosure is the correction value calculation method for the spectroscopic camera that calculates the spectral characteristic correction value of the wavelength variable spectral filter of the spectroscopic camera according to the first aspect of the present disclosure, the method including in a state where a spectral light source emits uniform light of a first wavelength having a uniform in-plane intensity is disposed at an imaging position of the first intermediate image, a spectral characteristic correction value is calculated such that the spectral sensitivity characteristic at the arbitrary correction point of the spectral image detected by the image sensor approaches the spectral sensitivity characteristic at a predetermined reference point of the spectral image or the predetermined spectral characteristic reference value.

In this configuration, in the spectroscopic camera according to the present disclosure, it is possible to perform calibration of the spectral sensitivity characteristic using uniform light for a portion with the respect to a position of the first intermediate image that reaches the image sensor through the second optical system and the wavelength variable spectral filter, and it is possible to correct the spectral sensitivity characteristic of an effective wavelength variable spectral filter even in a case where the interchangeable lens is replaced with any interchangeable lens having the first optical system.

What is claimed is:

1. A spectroscopic camera comprising:
a relay lens optical system configured to image light from an object and to generate a first intermediate image at a predetermined position;
a wavelength variable spectral filter configured to spectrally separate the light from the relay lens optical system;
an image sensor configured to detect the light from the wavelength variable spectral filter; and
a processor configured to correct a spectral sensitivity characteristic of the wavelength variable spectral filter, wherein
the processor is configured to correct the spectral sensitivity characteristic of the wavelength variable spectral filter so that the spectral sensitivity characteristic at an arbitrary correction point of a spectral image detected by the image sensor approaches a spectral sensitivity characteristic at a predetermined reference point of the spectral image or a predetermined spectral sensitivity characteristic reference value.

2. The spectroscopic camera according to claim 1, wherein
the relay lens optical system has an attachable and detachable first optical system configured to image the light from the object and to generate the first intermediate image at the predetermined position, and a second optical system configured to re-image the light from the first intermediate image on the image sensor,
the wavelength variable spectral filter is disposed between the first optical system and the second optical system or between the second optical system and the image sensor,
the wavelength variable spectral filter has a housing configured to accommodate the second optical system and the wavelength variable spectral filter, and
the housing is formed with a mount to which the first optical system is attachable.

3. The spectroscopic camera according to claim 1, wherein
the processor is configured to read a correction value stored in a storage and to correct the spectral sensitivity characteristic of the wavelength variable spectral filter, and
the correction value is a value calculated from the spectral image detected by the image sensor in a state where a spectral light source configured to emit uniform light of a first wavelength having a uniform in-plane intensity is disposed at an imaging position of the first intermediate image.

4. The spectroscopic camera according to claim 1, further comprising:
an additional optical system that is disposed between the first intermediate image and the wavelength variable spectral filter and that is configured to telecentrically convert light incident on the wavelength variable spectral filter, or an additional optical system that images the light from the first intermediate image on the wavelength variable spectral filter as a second intermediate image.

5. The spectroscopic camera according to claim 2, wherein
the light emitted from the second optical system is telecentric light.

6. A correction value calculation method for a spectroscopic camera for calculating a spectral characteristic correction value for the wavelength variable spectral filter of the spectroscopic camera according to claim 1, the method comprising:
in a state where a spectral light source emits uniform light of a first wavelength having a uniform in-plane intensity is disposed at an imaging position of the first intermediate image,
a spectral characteristic correction value is calculated such that the spectral sensitivity characteristic at the arbitrary correction point of the spectral image detected by the image sensor approaches the spectral sensitivity characteristic at a predetermined reference point of the spectral image or the predetermined spectral characteristic reference value.
